(19) United States
(12) Patent Application Publication
(10) Pub. No.: US 2020/0302227 A1
(43) Pub. Date: Sep. 24, 2020

(54) INFORMATION PROCESSING APPARATUS AND NON-TRANSITORY COMPUTER READABLE MEDIUM STORING INFORMATION PROCESSING PROGRAM

(71) Applicant: FUJI XEROX CO., LTD., Tokyo (JP)

(72) Inventor: Shuhei KOBAYAKAWA, Kanagawa (JP)

(73) Assignee: FUJI XEROX CO., LTD., Tokyo (JP)

(21) Appl. No.: 16/517,673

(22) Filed: Jul. 22, 2019

(30) Foreign Application Priority Data
Mar. 19, 2019 (JP) 2019-051939

(51) Int. Cl. G06K 9/62

(52) U.S. Cl. CPC G06K 9/6231; G06K 9/6262

(57) ABSTRACT

An information processing apparatus includes a first evaluation reception unit that receives an input evaluation for each element of a logical thinking diagram displayed on a screen of a terminal apparatus connected to the information processing apparatus via a communication line, a control unit that performs control such that evaluation information regarding the evaluation received by the first evaluation reception unit is displayed on the screen, and a definition unit that defines the element based on the evaluation information regarding the received evaluation or an instruction from a user.

### CROSS-REFERENCE TO RELATED APPLICATIONS

This application is based on and claims priority under 35 USC 119 from Japanese Patent Application No. 2019-051939 filed Mar. 19, 2019.

### BACKGROUND

### (i) Technical Field

The present invention relates to an information processing apparatus and a non-transitory computer readable medium storing an information processing program.

### (ii) Related Art

JP2014-174465A discloses an information processing apparatus including a text conversion unit that converts voice information into text; a word decomposition unit that decomposes the text obtained through conversion in the text conversion unit into words in a part of speech level; a conception support figure generation unit that generates a conception support figure represented by a two-dimensional drawing based on the words obtained through decomposition in the word decomposition unit; and an operation processing unit that executes a process according to an operation based on an operation on the conception support figure generated by the conception support figure generation unit.

### SUMMARY

In the related art, there is a case where a logical thinking diagram is completed while listening to opinions of a plurality of users by using a logical thinking diagram already completed or a case where a logical thinking diagram is completed by creating the logical thinking diagram while a plurality of users have a discussion together. In this case, an opinion of a specific user having the strong influence may be reflected in the logical thinking diagram, but an opinion of a specific user having the weak influence may not be reflected in the logical thinking diagram.

Aspects of non-limiting embodiments of the present disclosure relate to an information processing apparatus and a non-transitory computer readable medium storing an information processing program capable of completing a logical thinking diagram by taking into consideration opinions of a plurality of users.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a first evaluation reception unit that receives an input evaluation for each element of a logical thinking diagram displayed on a screen of a terminal apparatus connected to the information processing apparatus via a communication line; a control unit that performs control such that evaluation information regarding the evaluation received by the first evaluation reception unit is displayed on the screen; and a definition unit that defines the element based on the evaluation information regarding the received evaluation or an instruction from a user.

### BRIEF DESCRIPTION OF THE DRAWINGS

Exemplary embodiment(s) of the present invention will be described in detail based on the following figures, wherein:

FIG. 1 is a schematic configuration diagram illustrating an information processing system including an information processing apparatus according to the present exemplary embodiment;

FIG. 2 is a diagram illustrating an initial logic tree stored in the information processing apparatus according to the present exemplary embodiment;

FIG. 3 is a diagram illustrating a logic tree in which an evaluation is displayed by the information processing apparatus according to the present exemplary embodiment;

FIGS. 4A and 4B are diagrams illustrating a state in which an element defined by a definition unit of the information processing apparatus according to the present exemplary embodiment is displayed on a screen by a control unit;

FIGS. 5A and 5B are diagrams illustrating a in state in which relevance between elements defined by the definition unit of the information processing apparatus according to the present exemplary embodiment is displayed on a screen by the control unit;

FIGS. 6A and 6B are diagrams illustrating a in state in which relevance between elements defined by the definition unit of the information processing apparatus according to the present exemplary embodiment is displayed on a screen by the control unit;

FIGS. 7A and 7B are diagrams illustrating a in state in which relevance between elements defined by the definition unit of the information processing apparatus according to the present exemplary embodiment is displayed on a screen by the control unit;

FIG. 8 is a flowchart illustrating a flow of a process in the information processing apparatus according to the present exemplary embodiment;

FIG. 9 is a block diagram illustrating a hardware configuration of the information processing apparatus according to the present exemplary embodiment; and

FIG. 10 is a block diagram illustrating an example of a functional configuration of the information processing apparatus according to the present exemplary embodiment.

### DETAILED DESCRIPTION

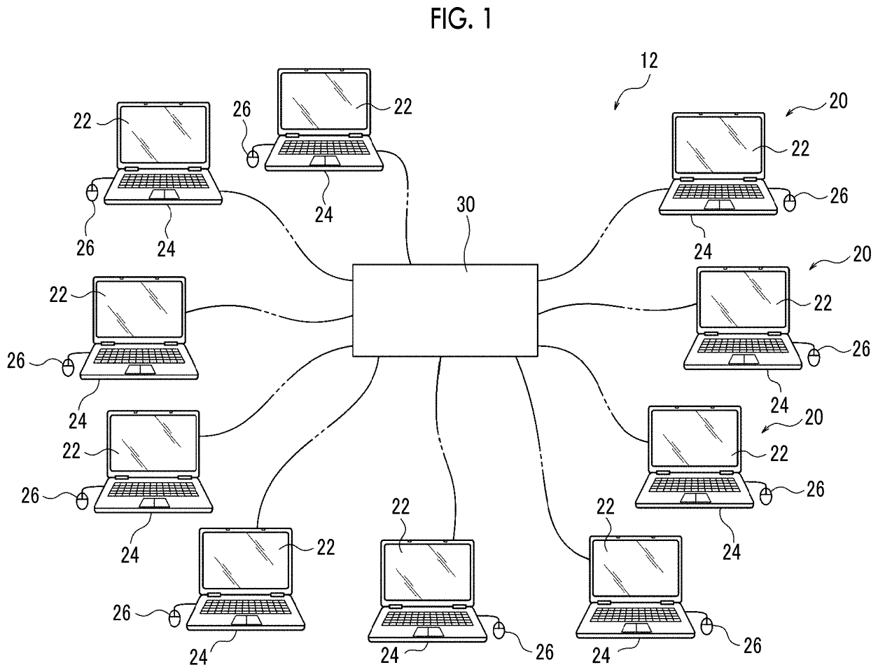

A description will be made of examples of an information processing apparatus and a non-transitory computer readable medium storing an information processing program with reference to FIGS. 1 to 10. An identical reference numeral is given to like or equivalent constituent elements and portions throughout the drawings. A dimension ratio in the drawings is exaggerated for convenience of description and may thus be different from an actual ratio.

Overall Configuration

As illustrated in FIG. 1, an information processing system 12 having an information processing apparatus 30 according to the present exemplary embodiment is configured to include a plurality of information processing terminals 20 and the information processing apparatus 30 which can perform communication with the plurality of information processing terminals 20. In the present exemplary embodiment, as an example, ten information processing terminals 20 can perform communication with the information processing apparatus 30.

Each of the plurality of information processing terminals 20 includes a screen 22, and a keyboard 24 and a mouse 26 with which information can be input, and the plurality of information processing terminals 20 are used by different users.

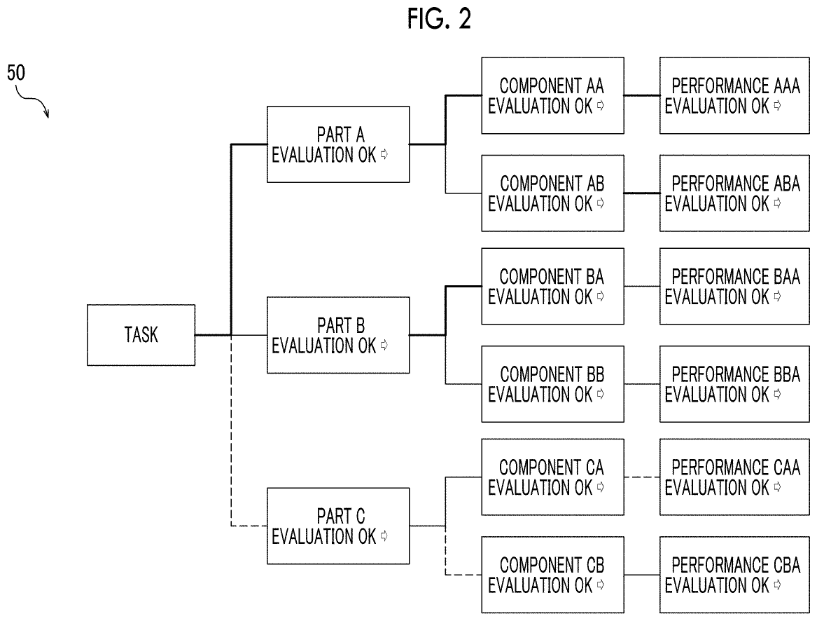

As illustrated in FIG. 2, a logic tree 50 which is an example of a logical thinking diagram is displayed on the screen 22 of each information processing terminal 20. The logic tree 50 illustrated in FIG. 2 is an initial (that is, uncompleted) logic tree 50 which is not evaluated by each user.

Each user may check the logic tree 50 displayed on the screen 22, and may input an evaluation for the logic tree 50 to the information processing terminal 20 by using the keyboard 24 and the mouse 26.

Hardware Configuration of Information Processing Apparatus 30

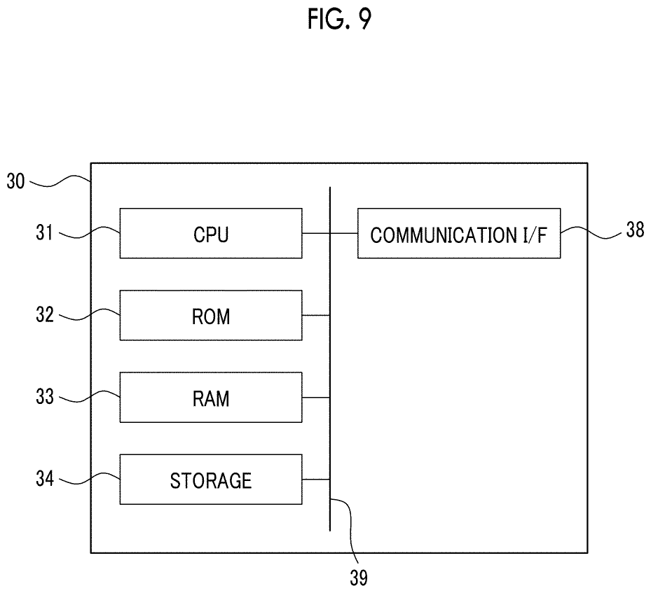

FIG. 9 is a block diagram illustrating a hardware configuration of the information processing apparatus 30.

As illustrated in FIG. 9, the information processing apparatus 30 includes a central processing unit (CPU) 31, a read only memory (ROM) 32, a random access memory (RAM) 33, a storage 34, and a communication interface (I/F) 38. The constituent elements are communicably connected to each other via a bus 39.

The CPU 31 is a central operation processing unit, and executes various programs or controls each unit. In other words, the CPU 31 reads an information processing program from the ROM 32 or the storage 34, and executes the information processing program with the RAM 33 as a work region. The CPU 31 performs control of each constituent element and various operation processes according to the information processing program recorded on the ROM 32 or the storage 34.

The ROM 32 stores various programs and various pieces of data. The RAM 33 is a work region and temporarily stores various programs or data. The storage 34 is configured with a hard disk drive (HDD) or a solid state drive (SSD), and stores various programs including an operating system, and various pieces of data.

Functional Configuration of Information Processing Apparatus 30

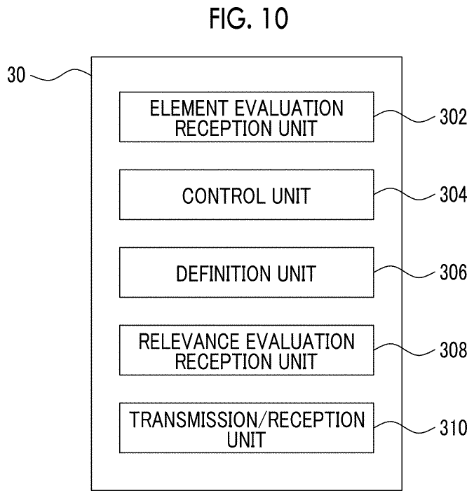

FIG. 10 is a block diagram illustrating an example of a functional configuration of the information processing apparatus 30.

As illustrated in FIG. 10, the information processing apparatus 30 has an element evaluation reception unit 302, a control unit 304, a definition unit 306, a relevance evaluation reception unit 308, and a transmission/reception unit 310. Each functional configuration is realized by the CPU 31 reading the information processing program stored in the ROM 32 or the storage 34, and executing the information processing program.

The information processing apparatus 30 is an apparatus completing a logic tree in which opinions of a plurality of users are reflected. The logic tree 50 which is an information processing target will be first described, and then a configuration of each unit will be described.

A “logic tree” in the present exemplary embodiment is a logical thinking diagram for deriving an appropriate course for settling a task or a problem when the task or the problem is given. In the logic tree 50 of the present exemplary embodiment, as illustrated in FIG. 2, with respect to a task (defect) of a certain device, in order to settle the task, a part which is a cause of the task is specified, and a component in the part which is a cause of the task is further specified. In the logic tree 50, performance of the component which is a cause of the task is also specified. In other words, in the present exemplary embodiment, elements written in the logic tree 50 are assumed to be a “task”, a “part”, a “component”, and “performance of the component”.

In the logic tree 50, in a case where relevance between elements is strong, the elements are connected to each other via a thick line, in a case where relevance between elements is normal, the elements are connected to each other via a thin line, and, in a case where relevance between elements is weak, the elements are connected to each other via a dashed line.

Element Evaluation Reception Unit 302

The element evaluation reception unit 302 receives an evaluation for each element of the logic tree 50 displayed on the screen 22 of the information processing terminal 20 from a user. The element evaluation reception unit 302 is an example of a first evaluation reception unit.

In this configuration, each user checks the logic tree 50 displayed on the screen 22, and performs an evaluation for each element of the logic tree 50. Specifically, the user performs an evaluation of validity for each element, and inputs “evaluation OK” to the information processing terminal 20 by using the keyboard 24 and the mouse 26 with respect to an element which the user considers to be valid. In a case where the user considers the element to be invalid, the user may input “evaluation NG” as an evaluation. Whenever an evaluation input by each user is received, the element evaluation reception unit 302 generates display information of evaluation information in which the received evaluations are collected, and the control unit 304 displays the evaluation information on the screen of each information processing terminal 20. As the evaluation information, in a case where the number of input “evaluation OKs” and “evaluation NGs” or the number of users required to input an evaluation is known, display such as “evaluation OK: 6/10” with the number of users as denominator may be performed, and a ratio between the pros and cons corresponding to evaluations of “evaluation OK” and evaluations of “evaluation NG” may be displayed.

As mentioned above, the evaluation information regarding evaluations received by the element evaluation reception unit 302 is information obtained by collecting evaluations received by the element evaluation reception unit 302. The obtained information is at least one of the number of evaluations, a proportion of pros or cons to the whole, or a ratio between the pros and cons.

Regarding an evaluation for an element, input from each information processing terminal 20, a single evaluation is possible for a single element. In this case, either one of “evaluation OK” or “evaluation NG” is input. The “task” is defined in advance, and is thus excluded from an evaluation target.

Relevance Evaluation Reception Unit 308

The relevance evaluation reception unit 308 receives an evaluation for strength and weakness of relevance between elements of the logic tree 50 displayed on the screen 22 of each information processing terminal 20. The relevance evaluation reception unit 308 is an example of a second evaluation reception unit.

In this configuration, each user checks the logic tree 50 displayed on the screen 22, and performs an evaluation for strength and weakness of relevance between elements of the logic tree 50. Specifically, the user performs an evaluation of validity for strength and weakness of relevance between elements, and inputs “evaluation OK” or “evaluation NG” to the information processing terminal 20 by using the keyboard 24 and the mouse 26 with respect to the strength and weakness of relevance which the user considers to be valid. Regarding an evaluation for strength and weakness of relevance between elements, input from each information processing terminal 20, a single evaluation is possible for a single element. As evaluation information regarding the input evaluation, the same display as the display content described in the element evaluation reception unit 302 may be performed.

As described above, the evaluation information regarding evaluations received by the relevance evaluation reception unit 308 is information obtained by collecting evaluations received by the relevance evaluation reception unit 308. The obtained information is at least one of the number of evaluations, a proportion of pros or cons to the whole, or a ratio between the pros and cons.

Definition Unit 306

The definition unit 306 defines an element based on the number of “evaluation OKs” received by the element evaluation reception unit 302. Here, an “element to be defined” indicates an element which is agreed to by a plurality of users as a result of the plurality of users evaluating the element of the logic tree 50.

The definition unit 306 defines strength and weakness of relevance between elements based on the number of “evaluation OKs” received by the relevance evaluation reception unit 308. Here, “strength and weakness of relevance between elements to be defined” indicates strength and weakness of relevance of elements agreed to by a plurality of users as a result of the plurality of users evaluating the strength and weakness of relevance between elements of the logic tree 50.

In this configuration, for example, the number of “evaluation OKs” received by the element evaluation reception unit 302 is six, the definition unit 306 defines the element. In a case where the number of “evaluation OKs” received by the relevance evaluation reception unit 308 is six or more, the definition unit 306 defines strength and weakness of relevance between elements. As mentioned above, the definition unit 306 functions as an evaluation determination unit determining whether or not an evaluation for an element and an evaluation for strength and weakness of relevance between elements performed by a user are OK.

Control Unit 304

The control unit 304 performs control such that evaluations received by the element evaluation reception unit 302 and the relevance evaluation reception unit 308 are displayed on each screen 22. Here, the “control” is to control the transmission/reception unit 310 such that evaluation information regarding evaluations received by the element evaluation reception unit 302 and the relevance evaluation reception unit 308 is displayed on the screen 22.

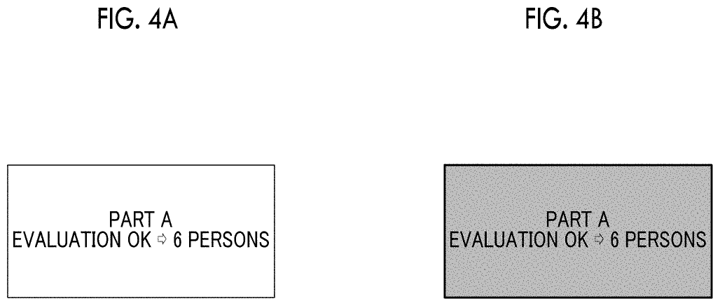

In this configuration, the control unit 304 displays the evaluation information received by the element evaluation reception unit 302 on each screen 22. For example, with respect to a part A as an element, in a case where six “evaluation OKs” are input from the information processing terminals 20, the control unit 304 displays “evaluation OK=>six persons” within a region of the element as illustrated in FIG. 4A. As illustrated in FIGS. 4A and 4B, the control unit 304 adds a color to the defined element, and makes a frame of the defined element thick. In FIG. 4B, the added color is illustrated by using dots. As mentioned above, the control unit 304 functions as a visual recognition unit which enables differentiation between a defined element and an undefined element to be visually recognized.

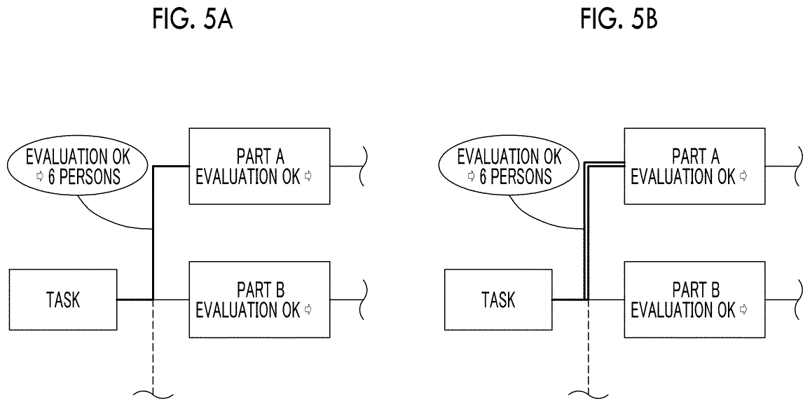

The control unit 304 displays the evaluation information received by the relevance evaluation reception unit 308 on each screen 22. For example, in a case where relevance between the task and the part A is displayed to be strong, and “evaluation OK” is input from six information processing terminals 20, as illustrated in FIG. 5A, the control unit 304 displays “evaluation OK=>six persons” with respect to a line indicating strength and weakness and connecting the task to the part A. As illustrated in FIGS. 5A and 5B, the control unit 304 doubles a thick line indicating defined strength and weakness of relevance between elements.

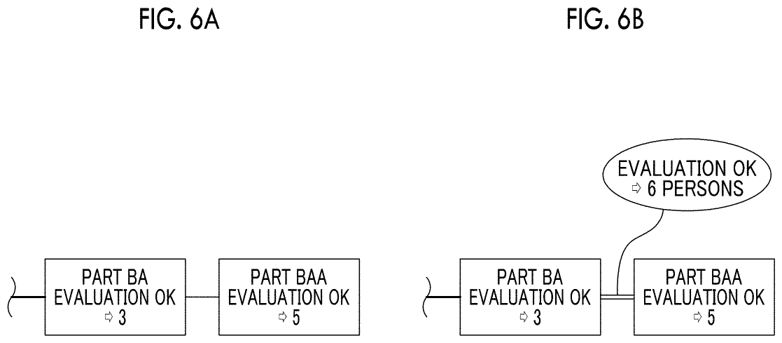

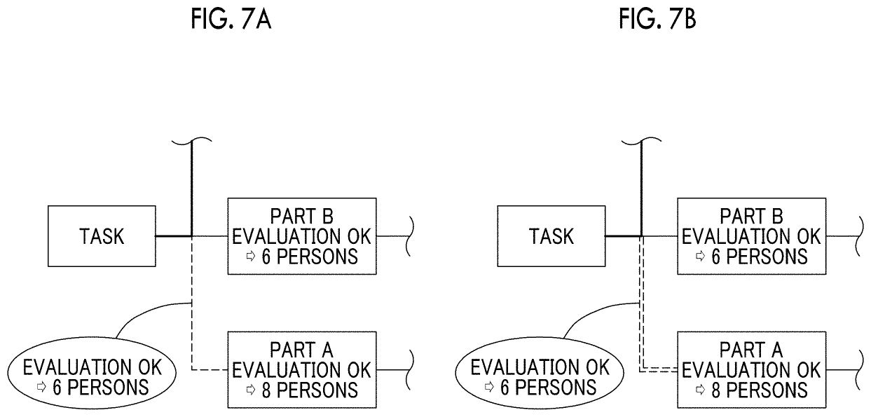

A case where a thin line is doubled is illustrated in FIGS. 6A and 6B, and a case where a dashed line is doubled is illustrated in FIGS. 7A and 7B.

Transmission/Reception Unit 310

The transmission/reception unit 310 receives various pieces of information which are input to each information processing terminal 20 by using the keyboard 24 and the mouse from the information processing terminal 20 connected thereto via a communication line. The transmission/reception unit 310 transmits various pieces of information from the information processing apparatus 30 to each information processing terminal 20.

As mentioned above, the transmission/reception unit 310 is an interface performing communication with each information processing terminal 20, and, for example, the information processing apparatus 30 may perform communication with each information processing terminal 20 via an intracompany local area network (LAN) or the Internet.

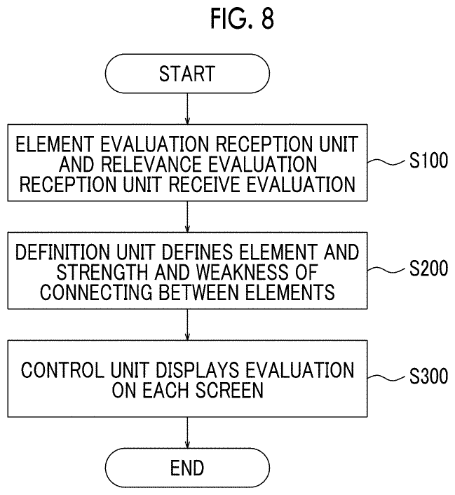

Next, with reference to a flowchart of FIG. 8, a description will be made of an operation of the information processing apparatus 30.

First, each user checks the initial logic tree 50 (refer to FIG. 2) displayed on the screen 22 (refer to FIG. 1).

Each user evaluates an element of the initial logic tree 50 and strength and weakness of relevance between elements.

Specifically, in order to settle the task, each user evaluates whether or not each element is valid, and inputs “evaluation OK” to the information processing terminal 20 by using the keyboard 24 and the mouse 26 with respect to an element which the user considers to be valid.

In order to settle the task, each user evaluates whether or not strength and weakness of relevance between elements is valid, and inputs “evaluation OK” to the information processing terminal 20 by using the keyboard 24 and the mouse 26 with respect to strength and weakness of relevance between elements which the user considers to be valid.

As mentioned above, each user evaluates an element and strength and weakness of relevance between elements under an identical condition regardless of strength and weakness of the influence of a user, or a user's social position. In other words, opinions of a plurality of users are considered in evaluation of the logic tree 50.

The transmission/reception unit 310 of the information processing apparatus 30 receives the evaluation information input from each user, from the information processing terminal 20.

Next, in step S100, the element evaluation reception unit 302 receives evaluation information for each element, and the relevance evaluation reception unit 308 receives evaluation information for strength and weakness of relevance between elements.

Next, in step S200, the definition unit 306 defines an element based on the number of “evaluation OKs” received by the element evaluation reception unit 302, and defines strength and weakness of relevance between elements based on the number of “evaluation OKs” received by the relevance evaluation reception unit 308.

Specifically, the definition unit 306 defines the element in a case where the number of “evaluation OKs” received by the element evaluation reception unit 302 is six or more. The definition unit 306 defines the strength and weakness of relevance between elements in a case where the number of “evaluation OKs” received by the relevance evaluation reception unit 308 is six or more.

The number of information processing terminals 20 used in the present exemplary embodiment is ten as described above. In other words, in a case where “evaluation OK” is input from a half or more of the information processing terminals 20, the definition unit 306 defines the element and the strength and weakness of relevance between elements.

Next, in step S300, the control unit 304 performs control such that evaluations received by the element evaluation reception unit 302 and the relevance evaluation reception unit 308 are displayed on each screen 22.

Specifically, with respect to the part A which is an element, in a case where six “evaluation OKs” are input from the information processing terminals 20, the control unit 304 displays “evaluation OK=>six persons” within the region of the element as illustrated in FIG. 4A. As illustrated in FIGS. 4A and 4B, the control unit 304 adds a color to the defined element, and makes a frame of the defined element thick.

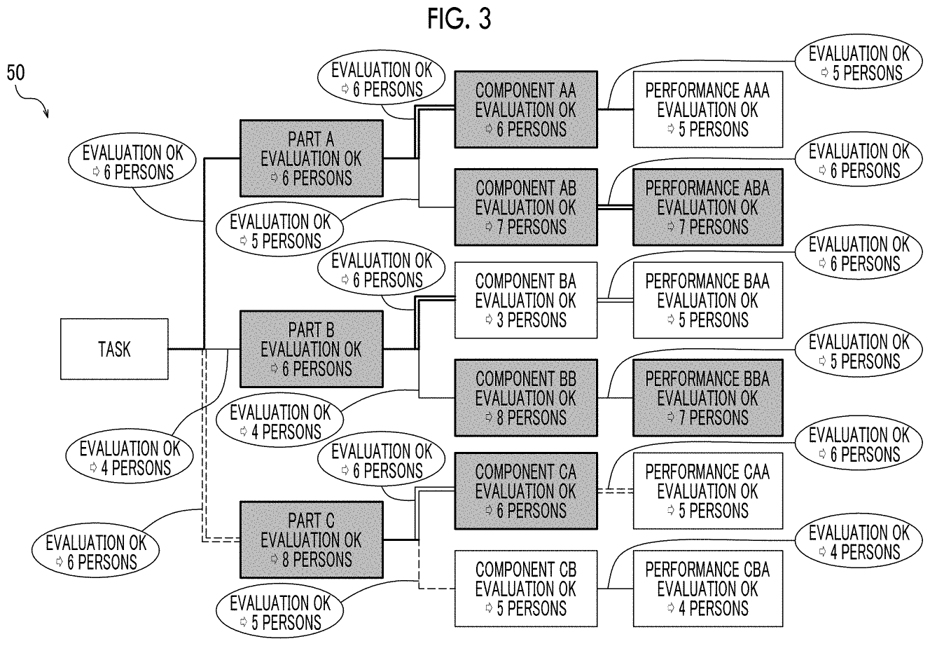

FIG. 3 illustrates the logic tree 50 of which elements and strength and weakness of relevance between elements are defined. In the logic tree 50, as elements, the “part A”, a “part B”, a “part C”, a “component AA”, a “component AB”, a “component BB”, a “component CA”, “performance ABA”, and “performance BBA” are defined.

In a case where relevance between the task and the part A is displayed to be strong, and “evaluation OK” is input from six information processing terminals 20, as illustrated in FIG. 5A, the control unit 304 displays “evaluation OK=>six persons” with respect to a line indicating strength and weakness and connecting the task to the part A. As illustrated in FIGS. 5A and 5B, the control unit 304 doubles a thick line indicating defined strength and weakness of relevance between elements.

In the logic tree 50 illustrated in FIG. 3, the “strength and weakness of relevance between the task and the part A”, the “strength and weakness of relevance between the task and the part C”, and the “strength and weakness of relevance between the part A and the component AA” are defined. In the logic tree 50, “strength and weakness of relevance between the part B and the component BA”, the “strength and weakness of relevance between the part C and the component CA”, the “strength and weakness of relevance between the component AB and the performance ABA”, “strength and weakness of relevance between the component BA and the performance BAA”, and the “strength and weakness of relevance between the component CA and the performance CAA” are defined.

The users discuss portions excluding the defined elements and portions excluding the defined strength and weakness of relevance between elements, and thus the logic tree 50 is completed.

### CONCLUSION

As described above, in the information processing apparatus 30, each user evaluates an element and strength and weakness of relevance between elements under an identical condition regardless of strength and weakness of the influence of a user, or a user's social position. As mentioned above, the logic tree 50 is completed by taking into consideration opinions of a plurality of users.

In the information processing apparatus 30, the control unit 304 displays a defined element to be differentiated from an undefined element on the screen 22. Consequently, each user's time required to examine the defined element is reduced. Thus, the time required for each user to examine the logic tree 50 is reduced compared with a case where a defined element and an undefined element are displayed not to be differentiated from each other on a screen.

In the information processing apparatus 30, the control unit 304 adds a color to a defined element so as to display the defined element to be differentiated from an undefined element on the screen 22. As mentioned above, a defined element and an undefined element are differentiated from each other to be visually recognized. Thus, a defined element and an undefined element are easily differentiated from each other by a user compared with a case where the defined element and the undefined element are differentiated from each other according to a sound difference occurring by clicking (indicating) the elements displayed on a screen.

In the information processing apparatus 30, the control unit 304 displays defined strength and weakness of relevance between elements to be differentiated from undefined strength and weakness of relevance between elements on the screen 22. Consequently, each user's time required to examine the defined strength and weakness of relevance between elements is reduced. Thus, the time required for each user to examine the logic tree 50 is reduced compared with a case where defined strength and weakness of relevance between elements and undefined strength and weakness of relevance between elements are displayed not to be differentiated from each other on a screen.

In the information processing apparatus 30, with respect to defined strength and weakness of relevance between elements, the control unit 304 doubles a line indicating the defined strength and weakness of relevance between elements so as to differentiate the defined strength and weakness of relevance between elements from undefined strength and weakness of relevance between elements. As mentioned above, defined strength and weakness of relevance between elements and undefined strength and weakness of relevance between elements are differentiated from each other to be visually recognized. Thus, defined strength and weakness of relevance between elements and undefined strength and weakness of relevance between elements are easily differentiated from each other by a user compared with a case where the defined strength and weakness of relevance between elements and the undefined strength and weakness of relevance between elements are differentiated from each other according to a sound difference occurring by clicking (indicating) lines indicating the strength and weakness of relevance between elements displayed on a screen.

In the information processing apparatus 30, evaluation information received by the element evaluation reception unit 302 and the relevance evaluation reception unit 308 is at least one of the number of evaluations, a proportion of pros or cons to the whole, or a ratio between the pros and cons. Consequently, at least one of the number of evaluations, a proportion of pros or cons to the whole, or a ratio between the pros and cons is displayed on the screen 22.

In the information processing program, the CPU 31 reads and executes the information processing program, and thus the logic tree 50 is completed by taking into consideration opinions of a plurality of users.

The present invention has been described in detail by using the specific exemplary embodiment, but the present invention is not limited to the related exemplary embodiment, and it is clear to a person skilled in the art that other various exemplary embodiments may be taken within the scope of the present invention. For example, in the exemplary embodiment, work using the information processing apparatus is started by each user checking the initial logic tree 50 displayed on the screen 22, but work using the information processing apparatus may be started by respective users creating a logic tree in cooperation on the screen.

In the exemplary embodiment, the definition unit 306 defines an element and strength and weakness of relevance between elements based on the number of “evaluation OKs” received by the element evaluation reception unit 302 and the relevance evaluation reception unit 308, but the definition unit may define an element and a strength and weakness of relevance between elements based on an instruction from a specific user.

In the exemplary embodiment, the control unit 304 adds a color to a defined element, and also makes a frame of the defined element thick, so as to differentiate the defined element from an undefined element, but may only add a color to the defined element so as to differentiate the defined element from an undefined element.

In the exemplary embodiment, the control unit 304 adds a color to a defined element, and also makes a frame of the defined element thick, so as to differentiate the defined element from an undefined element, but may add at least one of a shape or a mark to the defined element so as to differentiate the defined element from an undefined element. In this case, the degree of a size of a shape or a mark may be adjusted, and thus the magnitude of the number of “evaluation OKs” may be expressed. Specifically, in a case where the number of “evaluation OKs” is large, a shape or a mark may be larger than in a case where the number of “evaluation OKs” is small.

In the exemplary embodiment, the control unit 304 doubles a line indicating defined strength and weakness of relevance between elements so as to differentiate the defined strength and weakness of relevance between elements from undefined strength and weakness of relevance between elements. In other words, the control unit 304 adds a shape to a line indicating defined strength and weakness of relevance between elements so as to differentiate the defined strength and weakness of relevance between elements from undefined strength and weakness of relevance between elements. However, at least one of a color or a mark may be added to defined strength and weakness of relevance between elements, and thus the defined strength and weakness of relevance between elements may be differentiated from undefined strength and weakness of relevance between elements.

In the exemplary embodiment, although not particularly described, in a case where a certain element is defined, a higher-order element (that is, an element on an upstream side) of the certain element may be defined. This is because a logic tree is created through examination on an upstream side. Consequently, the time required for a user to evaluate the logic tree 50 is reduced.

In the exemplary embodiment, although not particularly described, respective users may input evaluations at different timings. In other words, it is not necessary to evaluate a logic tree in a location where users gather, the free time of each user is effectively used.

In the exemplary embodiment, although not particularly described, an input unit with which a user is enabled to input finishing of evaluation may be provided. Consequently, evaluation finishing of each user is easily understood.

In the exemplary embodiment, although not particularly described, an evaluation period may be set in advance, and an evaluation of each user may be considered to be finished according to expiration of the period.

In the exemplary embodiment, the logic tree 50 has been described as a logical thinking diagram, but other logical thinking diagrams such as a mind map may be used.

In the exemplary embodiment, information processing executed by the CPU 31 reading software (program) may be executed by various processors other than the CPU. Examples of the processors in this case may include a programmable logic device (PLD) such as a field-programmable gate array (FPGA) of which a circuit configuration is changeable after being manufactured, and a dedicated electric circuit which is a processor having a circuit configuration specially designed in order to execute a specific process, such as an application specific integrated circuit (ASIC). The information processing may be executed by one of the various processors, and may be executed by a combination of identical types or different types of two or more processors (for example, a combination of a plurality of FPGAs or a combination of a CPU and an FPGA). A hardware structure of each of the various processors is, for example, an electric circuit in which circuit elements such as semiconductor elements are combined with each other.

In the exemplary embodiment, a description has been made of an aspect in which the information processing program is stored in the ROM 32 or the storage 34 in advance, but this is only an example. The program may be provided in a form of being recorded on recording media such as a compact disk read only memory (CD-ROM), a digital versatile disk read only memory (DVD-ROM), and a Universal Serial Bus (USB). The program may be provided in a form of being downloaded from an external device via a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first evaluation reception unit that receives an input evaluation for each element of a logical thinking diagram displayed on a screen of a terminal apparatus connected to the information processing apparatus via a communication line;
a control unit that performs control such that evaluation information regarding the evaluation received by the first evaluation reception unit is displayed on the screen; and
a definition unit that defines the element based on the evaluation information regarding the received evaluation or an instruction from a user.

2. The information processing apparatus according to claim 1,
wherein the control unit displays the defined element to be differentiated from an undefined element on the screen.

3. The information processing apparatus according to claim 2,
wherein the control unit adds at least one of a color, a shape, or a mark to the defined element, so as to display the defined element to be differentiated from the undefined element on the screen.

4. The information processing apparatus according to claim 1,
wherein the evaluation information regarding the evaluation received by the first evaluation reception unit is information obtained by collecting evaluations received by the first evaluation reception unit, and
wherein the information obtained by collecting evaluations is at least one of the number of evaluations, a proportion of pros or cons to the whole, or a ratio between the pros and cons.

5. The information processing apparatus according to claim 2,
wherein the evaluation information regarding the evaluation received by the first evaluation reception unit is information obtained by collecting evaluations received by the first evaluation reception unit, and
wherein the information obtained by collecting evaluations is at least one of the number of evaluations, a proportion of pros or cons to the whole, or a ratio between the pros and cons.

6. The information processing apparatus according to claim 3,
wherein the evaluation information regarding the evaluation received by the first evaluation reception unit is information obtained by collecting evaluations received by the first evaluation reception unit, and
wherein the information obtained by collecting evaluations is at least one of the number of evaluations, a proportion of pros or cons to the whole, or a ratio between the pros and cons.

7. The information processing apparatus according to claim 1, further comprising:
a second evaluation reception unit that receives an evaluation for strength and weakness of relevance between elements of a logical thinking diagram displayed on a screen of a terminal apparatus connected to the information processing apparatus via a communication line,
wherein the control unit performs control such that evaluation information regarding the evaluation received by the second evaluation reception unit is displayed on the screen, and
wherein the definition unit defines the strength and weakness of relevance between elements based on the received evaluation or an instruction from a user.

8. The information processing apparatus according to claim 2, further comprising:
a second evaluation reception unit that receives an evaluation for strength and weakness of relevance between elements of a logical thinking diagram displayed on a screen of a terminal apparatus connected to the information processing apparatus via a communication line,
wherein the control unit performs control such that evaluation information regarding the evaluation received by the second evaluation reception unit is displayed on the screen, and
wherein the definition unit defines the strength and weakness of relevance between elements based on the received evaluation or an instruction from a user.

9. The information processing apparatus according to claim 3, further comprising:
a second evaluation reception unit that receives an evaluation for strength and weakness of relevance between elements of a logical thinking diagram displayed on a screen of a terminal apparatus connected to the information processing apparatus via a communication line,
wherein the control unit performs control such that evaluation information regarding the evaluation received by the second evaluation reception unit is displayed on the screen, and
wherein the definition unit defines the strength and weakness of relevance between elements based on the received evaluation or an instruction from a user.

10. The information processing apparatus according to claim 4, further comprising:
a second evaluation reception unit that receives an evaluation for strength and weakness of relevance between elements of a logical thinking diagram displayed on a screen of a terminal apparatus connected to the information processing apparatus via a communication line,
wherein the control unit performs control such that evaluation information regarding the evaluation received by the second evaluation reception unit is displayed on the screen, and
wherein the definition unit defines the strength and weakness of relevance between elements based on the received evaluation or an instruction from a user.

11. The information processing apparatus according to claim 5, further comprising:
a second evaluation reception unit that receives an evaluation for strength and weakness of relevance between elements of a logical thinking diagram displayed on a screen of a terminal apparatus connected to the information processing apparatus via a communication line,
wherein the control unit performs control such that evaluation information regarding the evaluation received by the second evaluation reception unit is displayed on the screen, and
wherein the definition unit defines the strength and weakness of relevance between elements based on the received evaluation or an instruction from a user.

12. The information processing apparatus according to claim 6, further comprising:
a second evaluation reception unit that receives an evaluation for strength and weakness of relevance between elements of a logical thinking diagram displayed on a screen of a terminal apparatus connected to the information processing apparatus via a communication line,
wherein the control unit performs control such that evaluation information regarding the evaluation received by the second evaluation reception unit is displayed on the screen, and
wherein the definition unit defines the strength and weakness of relevance between elements based on the received evaluation or an instruction from a user.

13. The information processing apparatus according to claim 7,
wherein the control unit displays the defined strength and weakness of relevance between elements to be differentiated from undefined strength and weakness of relevance between elements on the screen.

14. The information processing apparatus according to claim 8,
wherein the control unit displays the defined strength and weakness of relevance between elements to be differentiated from undefined strength and weakness of relevance between elements on the screen.

15. The information processing apparatus according to claim 9,
wherein the control unit displays the defined strength and weakness of relevance between elements to be differentiated from undefined strength and weakness of relevance between elements on the screen.

16. The information processing apparatus according to claim 10,
wherein the control unit displays the defined strength and weakness of relevance between elements to be differentiated from undefined strength and weakness of relevance between elements on the screen.

17. The information processing apparatus according to claim 11,
wherein the control unit displays the defined strength and weakness of relevance between elements to be differentiated from undefined strength and weakness of relevance between elements on the screen.

18. The information processing apparatus according to claim 13,
wherein the control unit adds at least one of a color, a shape, or a mark to the defined strength and weakness of relevance between elements, so as to display the defined strength and weakness of relevance between elements to be differentiated from the undefined strength and weakness of relevance between elements on the screen.

19. The information processing apparatus according to claim 7,
wherein the evaluation information regarding the evaluation received by the second evaluation reception unit is information obtained by collecting evaluations received by the second evaluation reception unit, and
wherein the information obtained by collecting evaluations is at least one of the number of evaluations, a proportion of pros or cons to the whole, or a ratio between the pros and cons.

20. A non-transitory computer readable medium storing an information processing program causing a computer of function as each unit of the information processing apparatus according to claim 1.
